(19) United States
(12) Patent Application Publication
(10) Pub. No.: US 2005/0260305 A1
(43) Pub. Date: Nov. 24, 2005

(54) Food supplement with separate flavoring system

(76) Inventors: Stephen Adele, Morrison, CO (US); Almario C. Basa, Placentia, CA (US)

Correspondence Address: SHERIDAN ROSS PC, 1560 BROADWAY, SUITE 1200, DENVER, CO, 80202, US

(21) Appl. No.: 10/853,562

(22) Filed: May 24, 2004

(51) Int. Cl. A23B 4/00

(52) U.S. Cl. 426/120

(57) ABSTRACT

The invention provides a food supplement kit including a bulk supply of a food supplement or dietary supplement and at least one individually packaged flavoring composition for mixing with and flavoring individual servings of the food supplement. This separation of food supplement and flavoring composition prevents oxidation of the flavoring composition ingredients and allows the consumer to choose different flavors for the food supplement for individual servings.

### FIELD OF THE INVENTION

The invention resides in the field of food supplements and specifically the flavoring of protein food supplements.

### BACKGROUND OF THE INVENTION

Food supplements have become increasingly popular for diet and exercise nutrition. These supplements principally contain protein, fat, carbohydrate and vitamin sources or specific combinations of these ingredients in a solid or liquid form designed to be consumed with food or as a meal replacement. One particularly popular system provides the food supplement in bulk as a solid or liquid that is intended to be mixed with food immediately prior to consumption. Protein supplements are a common example of these systems. Protein is provided as a dry powder, tablet, capsule or in a concentrated liquid source for purchase by the consumer. An aliquot of this protein source mixed with another food or beverage immediately prior to consumption.

Unfortunately, consumers find most of these supplements to have an unpleasant taste and texture necessitating steps to mask the taste of the supplement prior to consumption to make it palatable. This is typically accomplished by providing a strong flavoring agent or agents in the food supplement and it is not uncommon to find an individual food supplement available in several flavors. But flavoring agents and several vitamins and minerals are susceptible to oxidation and the use of these additives in a bulk food supplement package that is routinely opened and closed by the consumer leads to rapid oxidation of the susceptible contents. This oxidation causes a loss in flavor, sweetness and a dull or stale taste to the supplement during the course of storage and use of the supplement. Principal amongst the oxidation products are the sweeteners used in food supplements which can have a dull or rancid taste after oxidation. Similarly, several vitamins and minerals are also oxidized under these conditions resulting in decreased bioavailability and efficacy. This limits the shelf life of the bulk food supplement product or requires the packaging and sale of these products in smaller unit-of-use packaging. Thus, there is a need for a method of flavoring a food supplement that will render the supplement palatable to the consumer without becoming oxidized during the time over which a user will consume the supplement.

### SUMMARY OF THE INVENTION

The present invention provides a means of flavoring a food supplement while protecting the flavoring agents from oxidation due to repeated exposure of the bulk supplement ingredients to air. The invention encompasses a food supplement system that includes a bulk container of supplement ingredients such as vitamins, minerals, proteins and fats and a separate container of flavoring agents in a unit-of-use size designed to be mixed with a single serving of the supplement immediately prior to consumption.

One embodiment of the present invention is a food supplement kit including a food supplement and one or more individually-packaged flavoring compositions. The food supplement is an edible mixture that typically includes proteins, fats, carbohydrates, vitamins, minerals and combinations of these chemicals. Preferably, the food supplement contains proteins such as whey protein, soy protein, egg protein, milk protein or combinations of these protein sources. The flavoring composition may contain non-dairy creamer, dairy creamer, sweeteners such as sucralose, trehalose, saccharin, aspartame, glucose, sucrose, fructose or combinations of these sweeteners. The food supplement and the flavoring composition may independently be solid or liquid compositions. Solid food supplements are usually packaged in a single container between about 15 grams and about 8 pounds in weight. Liquid food supplements are usually packaged in a single container between about 30 milliliters and about 4 liters in volume. Flavoring compositions are usually packaged in air-tight packages suitable for use with an individual serving of the food supplement. An individual serving of a solid flavoring composition is typically between about 5 grams and about 30 grams in weight. An individual serving of a liquid flavoring composition is typically between about 5 milliliters and about 100 milliliters in volume. The food supplement kit usually contains written instructions for mixing an aliquot of the food supplement with the individually packaged flavor composition. These written instructions are provided with the bulk food supplement or the flavor composition or both.

Another embodiment of the present invention is a method of distributing a food supplement that includes supplying a bulk container of a food supplement and at least one container of a flavoring composition and providing written instructions of how to mix the container of flavoring composition with a portion of the food supplement.

Another embodiment of the present invention is a method of preparing a food supplement which includes mixing a portion of a bulk food supplement with the contents of an individual package of a flavoring agent.

Another embodiment of the present invention is a method of manufacturing a food supplement including combining edible ingredients to form a bulk food supplement and forming individual packages of a flavoring agent to be mixed with a portion of the bulk food supplement by the consumer of the food supplement.

### DETAILED DESCRIPTION OF THE INVENTION

The food supplement system of the present invention contains a bulk container of a food supplement and at least one separate container of a flavoring composition. The flavoring composition is designed to be mixed with, and to adequately flavor, a single serving size of the food supplement contained in the bulk container. The food supplement system may also contain additional packages of the same or different flavoring compositions all in individual serving sizes as well as separate packaging for two or more separate flavoring composition containers and instructional materials providing instructions for appropriately mixing, using or flavoring the bulk food supplement.

The food supplement may contain any edible ingredient intended to be consumed as a supplement to, or replacement of, a meal. Examples of suitable ingredients include proteins, carbohydrates, fats, vitamins and minerals. Proteins may be derived from any source including egg protein, whey protein, soy protein, milk proteins. Preferably, the protein includes combinations of these protein sources. Fats may be provided as saturated, unsaturated or partially unsaturated fatty acids, hydrogenated or unhydrolyzed fats, omega-3 and omega-6 fatty acids. Vitamins and minerals may be present in quantities that meet or exceed the United States recommended daily allowances when the bulk supplement is prepared and consumed.

Carbohydrates may be present as complex carbohydrates or in forms intended to add fiber to the diet of the consumer without absorption from the gastrointestinal tract. Simple sugars may also be present but these carbohydrates are susceptible to oxidation leading to the dull, stale or rancid tastes described above with bulk supplements containing sweeteners. Preferably, the bulk food supplement contains no sweeteners that are susceptible to oxidation including simple sugars and the like.

The food supplement may also contain edible compounds not typically included within the description of proteins, carbohydrates, fats, vitamins and minerals such as preservatives, antioxidants, starches, surfactants, solubilizing agents, stabilizing agents and the like. These compounds are often included in the food supplement as an aid to mixing or to increase the shelf life of the product.

The container for the food supplement is a package containing one or more servings of the food supplement. Preferably, the food supplement package contains more than one individual serving of the food supplement. Generally, the food supplement package contains between about 10 and about 500 individual servings of the food supplement. Typically, the food supplement contains between about 30 and about 100 individual servings of the food supplement. Depending upon the nature of the supplement, it may be provided in the packaging as a liquid or a solid. The food supplement is most often provided as a powder or a concentrated liquid. Preferably, the food supplement is provided as a dry powder. A dry powder food supplement may be provided in a package containing between about 15 grams and about 8 pounds of dry powder. Preferably, a dry powder food supplement is provided in a package containing between about 60 grams and about 4 pounds of dry powder. More preferably, a dry powder food supplement is provided in a package containing about 2 pounds of dry powder. A liquid food supplement may be provided in a package containing between about 30 milliliters and about 4 liters of liquid. Preferably, a liquid food supplement is provided in a package containing between about 120 milliliters and about 1 liter of liquid. More preferably, a liquid food supplement is provided in a package containing about 500 milliliters of liquid.

The flavoring composition may contain one or more sweeteners, dairy or non-dairy creamers, natural or artificial flavors, fruits, candies, cookies, or other carbohydrates as well as preservatives and mixing aides. The sweeteners may include sucralose, trehalose, saccharin, aspartame, glucose, sucrose, fructose and the like. Preferably, the sweetener is sucralose. The flavoring composition also preferably contains a freeze-dried dairy creamer. Pieces of fruit, cookies and candies are optionally included in the flavoring composition to enhance both the flavor and the texture of the food supplement after appropriate mixing with the flavor composition by the consumer. Preferably, any pieces of cookie, candy or fruit present in the flavoring composition are dried and crushed or ground to be no larger than about one-quarter inch in the longest dimension. Examples of dried and/or crushed ingredients suitable for use in the flavor packets of the present invention include strawberry pieces, graham cracker pieces, chocolate cookie pieces. The flavoring composition may also contain natural and artificial flavors. For example, natural flavorings may include natural chocolate flavor, natural strawberry flavor and natural butter flavor. Suitable artificial flavorings include artificial cream flavors, artificial cinnamon flavor and artificial peanut flavor. Natural and artificial flavorings are available commercially from many sources such as WILD Flavors, Inc. and Gold Coast Ingredients, Inc.

The flavoring composition may be a liquid or a solid. Preferably, the flavoring composition is a dry powder. The weight of a dry flavoring composition is between about 5 grams and about 30 grams. Preferably, the weight of a dry flavoring composition is between about 10 grams and about 20 grams. More preferably, the weight of a dry flavoring composition is between about 12 grams and about 15 grams. The volume of a liquid flavoring composition is between about 5 milliliters and about 100 milliliters. Preferably, the volume of a liquid flavoring agent is between about 15 milliliters and about 30 milliliters.

The packaging for the flavoring composition is air tight to protect the ingredients of the flavor composition from oxidation. The packaging is either a sealed packet or an air-tight liquid container. Preferably, the package is a foil packet that can be heat sealed to prevent oxidation of the contents and then easily ripped open to release the contents for mixing with the food supplement prior to consumption by the consumer. These packages of the flavor composition are preferably enclosed within a larger container enclosing a multitude of flavor packages of the same or different flavors for purchase by the consumer. Beyond preventing the oxidation of the flavoring composition ingredients, this food supplement system allows the consumer to change the flavor of the food supplement with each individual consumption of the supplement without having to buy multiple individually-flavored bulk containers of the food supplement.

Instructional materials describing the proper mixing and use of the food supplement may be included with the food supplement container or the flavoring composition container or both. Typically, these materials are written instructions providing a description of the amounts of the food supplement to be mixed with the contents of the individual flavoring composition container as well as specifications about the food supplement or flavoring composition or suggestions for mixing and serving the food supplement.

### EXAMPLES

### Example 1

This example provides the ingredient list of a protein powder food supplement for use in the food supplement system of the present invention. Two pounds of the meal replacement powder described by these ingredients is supplied in a bulk multi-use container. The unflavored food supplement contains Microfiltered Whey Protein Isolate, Whey Protein Concentrate, Calcium Caseinate, Hydrolyzed Oat Flour, High Oleic Sunflower Oil, Soluble Dietary Fiber, Cellulose Gel and Gum, Fructooligosaccharides, Soy Lecithin, L-Glutamine, Magnesium Oxide, Dipotassium Phosphate, Ferrous Phosphate, Ascorbic Acid, alpha Tocopheryl Acetate, Niacinamide, Zinc Oxide, Vitamin A Palmitate, d-Calcium Pantothenate, Manganese Sulfate, Copper Sulfate, Pyridoxine Hydrochloride, Riboflavin, Thiamin Hydrochloride, Chromium Polynicotinate, Vitamin D3, Folic Acid, Biotin, Potassium Iodine, Sodium Molybdate, Sodium Selenite, Vitamin K, and Cyanocobalamin), Potassium Chloride, Natural and Artificial Flavor, Sodium Caseinate, Sucralose, Flaxseed Oil, Lactobacillius Acidophillus, and Bifidobacterium Bifidum.

### Example 2

This example provides the ingredient list of an individual flavoring composition suitable for use in the food supplement system of the present invention. Thirteen grams of the flavoring composition described by these ingredients is supplied in an individual sealed packet for mixing with the bulk food supplement powder described in Example 1. The flavoring composition contains natural chocolate flavor, artificial chocolate cookie pieces, dutch-processed cocoa and sucralose.

### Example 3

This example provides the ingredient list of an individual flavoring composition suitable for use in the food supplement system of the present invention. Ten grams of the flavoring composition described by these ingredients is supplied in an individual sealed packet for mixing with the bulk food supplement powder described in Example 1. The flavoring composition contains natural strawberry flavor, artificial cream flavor, freeze dried strawberry pieces and sucralose.

### Example 4

This example provides the ingredient list of an individual flavoring composition suitable for use in the food supplement system of the present invention. Fifteen grams of the flavoring composition described by these ingredients is supplied in an individual sealed packet for mixing with the bulk food supplement powder described in Example 1. The flavoring composition contains natural butter flavor, artificial cinnamon flavor, graham cracker pieces and sucralose.

### Example 5

This example provides the ingredient list of an individual flavoring composition suitable for use in the food supplement system of the present invention. Nine grams of the flavoring composition described by these ingredients is supplied in an individual sealed packet for mixing with the bulk food supplement powder described in Example 1. The flavoring composition contains natural chocolate flavor, artificial peanut flavor, dutch-processed cocoa and sucralose.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A food supplement kit comprising:
a. A food supplement;
b. At least one individually-packaged flavoring composition.

2. The food supplement kit of claim 1, wherein the food supplement comprises an edible ingredient selected from the group consisting of a protein, a fat, a carbohydrate, a vitamin, a mineral and combinations thereof.

3. The food supplement kit of claim 1, wherein the food supplement comprises a protein selected from the group consisting of whey protein, soy protein, egg protein, milk protein and combinations thereof.

4. The food supplement kit of claim 1, wherein the flavoring composition comprises at least one of non-dairy creamer, dairy creamer and a sweetener selected from the group consisting of sucralose, trehalose, saccharin, aspartame, glucose, sucrose, fructose and combinations thereof.

5. The food supplement kit of claim 1, wherein the flavoring composition comprises dairy creamer and sucralose.

6. The food supplement kit of claim 1, wherein the food supplement is a solid supplement present in an amount of between about 15 grams and about 8 pounds in a single container.

7. The food supplement kit of claim 1, wherein the food supplement is a solid supplement present in an amount of between about 60 grams and about 4 pounds in a single container.

8. The food supplement kit of claim 1, wherein the food supplement is a solid supplement present in an amount of about 2 pounds in a single container.

9. The food supplement kit of claim 1, wherein the food supplement is a liquid supplement present in an amount of between about 30 milliliters and about 4 liters in a single container.

10. The food supplement kit of claim 1, wherein the food supplement is a liquid supplement present in an amount of between about 120 milliliters and about 1 liter in a single container.

11. The food supplement kit of claim 1, wherein the food supplement is present in an amount representing between about 10 and about 500 individual servings in a single container.

12. The food supplement kit of claim 1, wherein the food supplement is present in an amount representing between about 30 and about 100 individual servings in a single container.

13. The food supplement kit of claim 1, wherein the flavoring composition comprises a natural flavor selected from the group consisting of chocolate flavor, strawberry flavor, and butter flavor.

14. The food supplement kit of claim 1, wherein the flavoring composition comprises an artificial flavor selected from the group consisting of chocolate flavor, cream flavor, peanut flavor and cinnamon flavor.

15. The food supplement kit of claim 1, wherein the flavoring composition is a solid composition present in an amount between about 5 grams and about 30 grams in a single container.

16. The food supplement kit of claim 1, wherein the flavoring composition is a solid composition present in an amount between about 10 grams and about 20 grams in a single container.

17. The food supplement kit of claim 1, wherein the flavoring composition is a solid composition present in an amount between about 12 grams and about 15 grams in a single container.

18. The food supplement kit of claim 1, wherein the flavoring composition is a liquid composition present in an amount between about 5 milliliters and about 100 milliliters in a single container.

19. The food supplement kit of claim 1, wherein the flavoring composition is a liquid composition present in an amount between about 15 milliliters and about 30 milliliters in a single container.

20. The food supplement kit of claim 1, further comprising written instructions for mixing an aliquot of the food supplement with the individually packaged flavor composition.

21. The food supplement kit of claim 1, comprising at least about 10 packages of individually-packaged flavoring compositions.

22. The food supplement kit of claim 21, wherein the kit comprises at least 2 different flavoring compositions.

23. A flavoring composition comprising sucralose and dairy creamer in an amount sufficient to flavor one serving of a food supplement.

24. The flavoring composition of claim 23, wherein the flavoring composition is a solid composition present in an amount between about 5 grams and about 30 grams in a single container.

25. The flavoring composition of claim 23, wherein the flavoring composition is a liquid composition present in an amount between about 5 milliliters and about 100 milliliters in a single container.

26. A method of distributing a food supplement comprising:
a. supplying a bulk container of a food supplement;
b. supplying at least one container of a flavoring composition, wherein the container contains one individual serving of the flavoring composition;
c. providing written instructions of how to mix the at least one container of a flavoring composition with an aliquot of the food supplement.

27. A method of preparing a food supplement comprising mixing an aliquot of a bulk food supplement with the contents of an individual package of a flavoring agent wherein the bulk food supplement comprises a protein source selected from the group consisting of whey protein, soy protein, egg protein, milk protein and combinations thereof, and wherein the individual package of flavoring agent comprises sucralose and dairy creamer.

28. A method of preparing a food supplement comprising mixing an aliquot of a bulk food supplement with the contents of an individual package of a flavoring agent wherein the bulk food supplement consists of microfiltered whey protein isolate, whey protein concentrate, calcium caseinate, hydrolyzed oat flour, high oleic sunflower oil, soluble dietary fiber, cellulose gel and gum, fructooligosaccharides, soy lecithin, 1-glutamine, magnesium oxide, dipotassium phosphate, ferrous phosphate, ascorbic acid, alpha tocopheryl acetate, niacinamide, zinc oxide, vitamin a palmitate, d-calcium pantothenate, manganese sulfate, copper sulfate, pyridoxine hydrochloride, riboflavin, thiamin hydrochloride, chromium polynicotinate, vitamin D3, folic acid, biotin, potassium iodine, sodium molybdate, sodium selenite, vitamin k, and cyanocobalamin), potassium chloride, natural and artificial flavor, sodium caseinate, sucralose, flaxseed oil, lactobacillius acidophillus, and bifidobacterium bifidum, and wherein the individual package of flavoring agent comprises sucralose, dairy creamer and at least one of chocolate and dried strawberries.

29. A method of manufacturing a food supplement comprising:
a. combining edible ingredients to form a bulk food supplement; and,
b. forming individual packages of a flavoring agent to be mixed with an aliquot of the bulk food supplement by the consumer of the food supplement.

30. The method of claim 29, wherein the bulk food supplement comprises whey protein, and calcium caseinate.

31. The method of claim 29, wherein the flavoring agent comprises sucralose and at least one of a natural flavor and an artificial flavor.
